(19) United States
(12) Patent Application Publication
(10) Pub. No.: US 2020/0184883 A1
(43) Pub. Date: Jun. 11, 2020

(54) UNEVENNESS CORRECTION DATA GENERATION DEVICE

(71) Applicant: IIX INC., Tokyo (JP)

(72) Inventors: Hiroshi MURASE, Tokyo (JP); Takashi SAKAMOTO, Tokyo (JP); Makoto HATAKENAKA, Tokyo (JP)

(73) Assignee: IIX INC., Tokyo (JP)

(21) Appl. No.: 16/618,623

(22) PCT Filed: May 31, 2017
(86) PCT No.: PCT/JP2017/020299

§ 371 Date: Dec. 2, 2019

(51) Int. Cl. G09G 3/3208

(52) U.S. Cl. CPC G09G 3/3208; G09G 2320/02; G09G 2300/0465; G09G 2310/061; G09G 2310/08

(57) ABSTRACT

An unevenness correction data generation device capable of preventing capturing of a black band caused by rewriting a display image when capturing an image of a display panel in order to generate unevenness correction data for the display panel. The device includes a pattern generation device configured to output an image signal and a synchronization signal to an organic EL panel; a camera configured to capture a display image of the organic EL panel to which the image signal was input; and an image quality adjustment device configured, based on the results of image capturing by the camera, to generate unevenness correction data for correcting unevenness of the organic EL panel. The camera captures the display image by opening a shutter from one vertical blanking period to another vertical blanking period of the display image, based on the synchronization signal from the pattern generation device.

### TECHNICAL FIELD

The present invention relates to an unevenness correction data generation device configured to generate unevenness correction data for correcting unevenness of a display panel.

### BACKGROUND ART

In display panels such as liquid crystal panels and organic EL panels, it is known that display unevenness (luminance unevenness, or color unevenness) occurs due to manufacturing variations. In a case where each pixel of the display panel has R, G, and B sub-pixels, the relative brightness relationship of R, G, and B in an individual pixel does not vary, but when there is a difference in the absolute brightness between adjacent pixels, luminance unevenness occurs. Also, when the relative brightness relationship of R, G, and B in an individual pixel varies between adjacent pixels, color unevenness occurs. In particular, in an organic EL panel, it is difficult to make the thickness of an organic compound layer the same for each pixel, so display unevenness caused by uneven layer thickness easily occurs, and as a result it is not easy to achieve a large screen.

As a technique for reducing such display unevenness and improving the image quality of a display panel, there is, for example, an image correction data generation system described in Patent Document 1. In this system, a signal value that is common to the entire display panel is supplied to display a test pattern, an image of the displayed test pattern is captured by a camera, band pass filter processing or the like is performed on the image captured by the camera, and correction data for reducing unevenness of the display panel is generated. When a correction circuit in which this correction data is stored is incorporated into the display panel, the input signal of the display panel can be corrected, thereby improving the image quality of the display panel.

### CITATION LIST

### Patent Document

Patent Document 1: JP 2013-250570A

### SUMMARY OF INVENTION

### Technical Problem

Incidentally, when an image of an organic EL panel is captured by a camera, a thin black band in the horizontal line direction may be captured. The reason for this is that a line not emitting light is being moved so as to scan on the display panel due to switching off a drive current when rewriting a display image of the display panel. This black band moves at a speed as high as the frame rate (60 fps) and therefore is not recognized by human eyes, but is recognized by the camera as described above, and is necessary in the driving system of the panel, so this black band cannot be easily eliminated.

Furthermore, if the black band appears when capturing an image of the display panel in order to generate unevenness correction data for the display panel, the thin black band may also be generated as actual unevenness, and from the captured image it is difficult to discriminate whether this is a black band captured for the above-described reasons or this is real unevenness, and when correction data is generated by also processing a black band captured for the above-described reasons as unevenness, this results in a problem that a thin bright line is included in the image after correction.

The present invention has been made in view of the above-described circumstances, and aims to provide an unevenness correction data generation device capable of preventing capturing of a black band caused by rewriting a display image when capturing an image of a display panel in order to generate unevenness correction data for the display panel.

### Solution to Problem

In order to address the above-described problems, an unevenness correction data generation device according to the present invention includes: a signal generation means for outputting an image signal and a synchronization signal to a display panel; an image capturing means for capturing a display image of the display panel to which the image signal was input; and a data generation means for, based on the results of image capturing by the image capturing means, generating unevenness correction data for correcting unevenness of the display panel. The image capturing means captures the display image by opening a shutter from one vertical blanking period to another vertical blanking period of the display image, based on the synchronization signal.

According to this unevenness correction data generation device, the image capturing means captures the display image by opening the shutter from one vertical blanking period to another vertical blanking period of the display image, based on the synchronization signal of the signal generation means, so exposure is performed while the black band caused by rewriting the display image moves from one end of the display panel to the other end exactly once or a plurality of times, and the black band affects the captured image not partially but overall, and therefore a band-like area of low luminance is not created in the captured image. Consequently, it is possible to prevent capturing of a black band caused by rewriting a display image when capturing an image of a display panel in order to generate unevenness correction data for the display panel.

The other vertical blanking period may be the next vertical blanking period after the one vertical blanking period, and according to this configuration, exposure is performed only while the black band caused by rewriting the display image moves from one end of the display panel to the other end exactly once. Therefore, it is possible to complete image capturing of the display panel in an extremely short time period of about the reciprocal of the frame rate (if the frame rate is 60 fps, about 1/60 of a second).

The image capturing means may capture the display image at an aperture value not exceeding a latitude when the shutter is opened from the one vertical blanking period to the next vertical blanking period. According to this configuration, it is possible to prevent a situation where effective unevenness correction data is not generated due to blown out highlights or saturation of the captured image.

Also, the unevenness correction data generation device may be provided with an ND filter configured to be inserted into or removed from an optical system of the image capturing means, and a transparent member with substantially the same air conversion length as the ND filter and configured to be inserted into or removed from the optical system instead of the ND filter. According to this configuration, in a case where it seems likely that the latitude will be exceeded when the shutter is opened from one vertical blanking period to another vertical blanking period, the ND filter is inserted into the optical system of the image capturing means to prevent a situation where effective unevenness correction data is not generated due to blown out highlights or saturation of the captured image. On the other hand, when the ND filter is not inserted, the transparent member with substantially the same air conversion length as the ND filter is inserted to maintain the same refractive index as a state in which the ND filter is inserted. Thus, focus adjustment expected to be necessary due to the presence or absence of the ND filter (due to a change in the refractive index) can be made unnecessary.

Alternatively, the signal generation means may be capable of changing the interval (frame rate) of the vertical blanking period of the display image. According to this configuration, in a case where it seems likely that the latitude will be exceeded when the shutter is opened from one vertical blanking period to another vertical blanking period, by reducing the interval (increasing the frame rate) of the vertical blanking period, it is possible to prevent a situation where effective unevenness correction data is not generated due to blown out highlights or saturation of the captured image.

### Advantageous Effects of Invention

According to the unevenness correction data generation device of the present invention, it is possible to prevent capturing of a black band caused by rewriting a display image when capturing an image of a display panel in order to generate unevenness correction data for the display panel.

### BRIEF DESCRIPTION OF DRAWINGS

FIG. 1 is an explanatory view showing an unevenness correction data generation device according to an example embodiment of the present invention.

FIG. 2 is a flowchart chronologically showing operation of the unevenness correction data generation device in FIG. 1.

FIG. 3 is an explanatory view showing opening/closing timing of a shutter of the unevenness correction data generation device in FIG. 1.

FIG. 4 is an explanatory view showing another example of the unevenness correction data generation device according to an example embodiment of the present invention.

### DESCRIPTION OF EMBODIMENTS

Following is a description of an example embodiment of the present invention, with reference to the attached drawings.

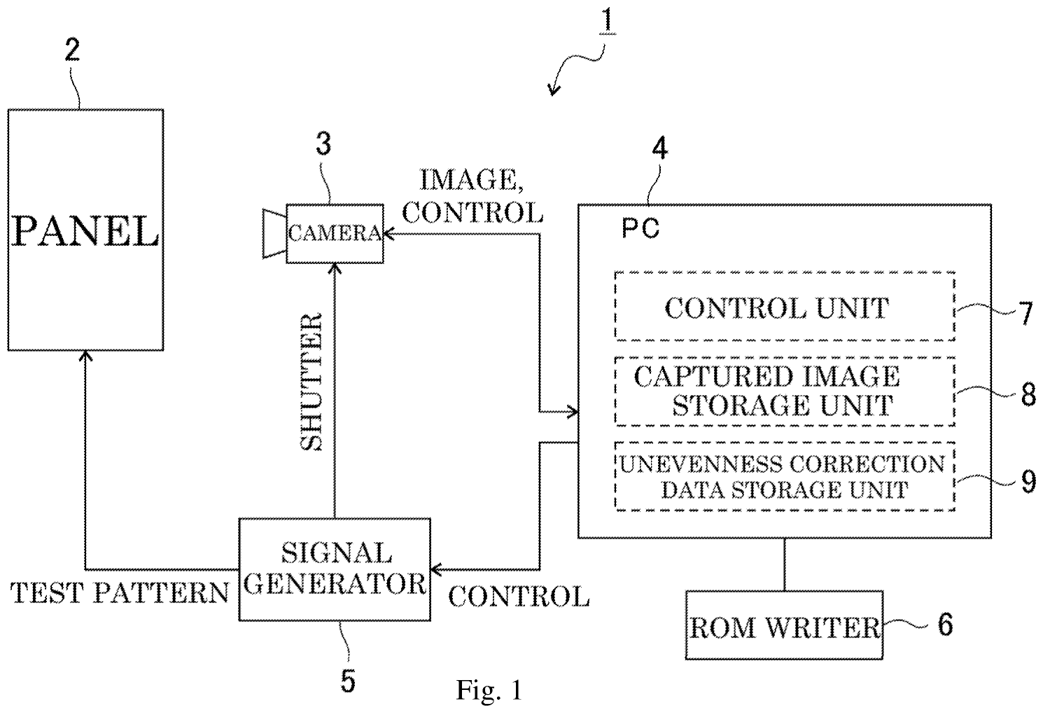

FIG. 1 shows an unevenness correction data generation device according to this example embodiment. The unevenness correction data generation device 1 causes an organic EL panel 2 to display various patterns, captures an image with a monochrome fixed image capturing element-type camera 3, and generates unevenness correction data for reducing display unevenness of the organic EL panel 2. The generated unevenness correction data is stored in a ROM (nonvolatile memory) of an image quality adjustment circuit not shown, and the image quality adjustment circuit is installed in the organic EL panel 2 to manufacture an organic EL panel with adjustable image quality. In this organic EL panel with adjustable image quality, the image quality adjustment circuit corrects an image signal (input signal) that was input to the organic EL panel 2 with reference to the unevenness correction data stored in the ROM, and thus image quality is adjusted so as to achieve a reduction in display unevenness of the organic EL panel 2.

The unevenness correction data generation device 1 includes an image quality adjustment device (PC) 4 to which the camera 3 can be connected, a pattern generation device 5 configured to be connected to the organic EL panel 2 and the image quality adjustment device 4, and a ROM writer 6 configured to be connected to the image quality adjustment device 4. The image quality adjustment device 4 includes a control unit 7, a captured image storage unit 8, and an unevenness correction data storage unit 9.

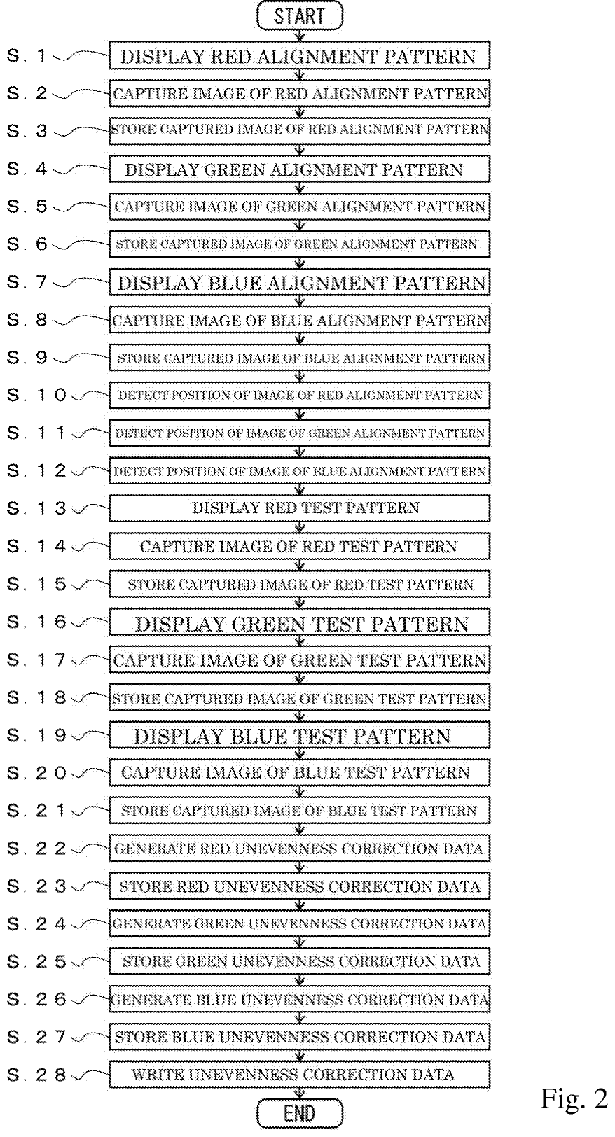

As shown in FIG. 2, when the unevenness correction data generation device 1 generates unevenness correction data, first, the control unit 7 of the image quality adjustment device 4 instructs the pattern generation device 5 to transmit an alignment pattern display signal (R signal) to the organic EL panel 2, and displays a red alignment pattern in which specific pixels of the organic EL panel 2 are lit in red on the organic EL panel 2 (step 1 (noted as “S. 1” in the drawing, same hereinafter)). The control unit 7 causes the camera 3 to capture an image of the organic EL panel 2 on which the red alignment pattern is displayed (step 2), and stores the captured image of the red alignment pattern in the captured image storage unit 8 (step 3).

Next, the control unit 7 instructs the pattern generation device 5 to transmit an alignment pattern display signal (G signal) to the organic EL panel 2, and displays a green alignment pattern in which specific pixels of the organic EL panel 2 are lit in green on the organic EL panel 2 (step 4). The control unit 7 causes the camera 3 to capture an image of the organic EL panel 2 on which the green alignment pattern is displayed (step 5), and stores the captured image of the green alignment pattern in the captured image storage unit 8 (step 6).

Next, the control unit 7 instructs the pattern generation device 5 to transmit an alignment pattern display signal (B signal) to the organic EL panel 2, and displays a blue alignment pattern in which specific pixels of the organic EL panel 2 are lit in blue on the organic EL panel 2 (step 7). The control unit 7 causes the camera 3 to capture an image of the organic EL panel 2 on which the blue alignment pattern is displayed (step 8), and stores the captured image of the blue alignment pattern in the captured image storage unit 8 (step 9).

After completion of this series of image capturing, the control unit 7 detects the position of the image of the red alignment pattern on the image capturing plane of the camera 3 based on the captured image of the red alignment pattern stored in the captured image storage unit 8 (step 10). That is, assuming that dots on the captured image of the red alignment pattern correspond to the red lighting of the above-described specific pixels, the control unit 7 detects which image capturing elements on the imaging plane of the camera 3 that the image of the above-described specific pixels correspond to when red display is performed.

Likewise, the control unit 7 detects the position of the image of the green alignment pattern on the imaging plane of the camera 3 based on the captured image of the green alignment pattern stored in the captured image storage unit 8 (step 11), and detects the position of the image of the blue alignment pattern on the imaging plane of the camera 3 based on the captured image of the blue alignment pattern stored in the captured image storage unit 8 (step 12).

After detecting the position of the image of each alignment pattern on the imaging plane of the camera 3, the control unit 7 instructs the pattern generation device 5 to transmit a test pattern display signal (R signal) to the organic EL panel 2, and displays a red test pattern on the organic EL panel 2 (step 13). The red test pattern is a red image displayed on the entire organic EL panel 2, in which all the pixels of the organic EL panel 2 exhibit red with a predetermined tone.

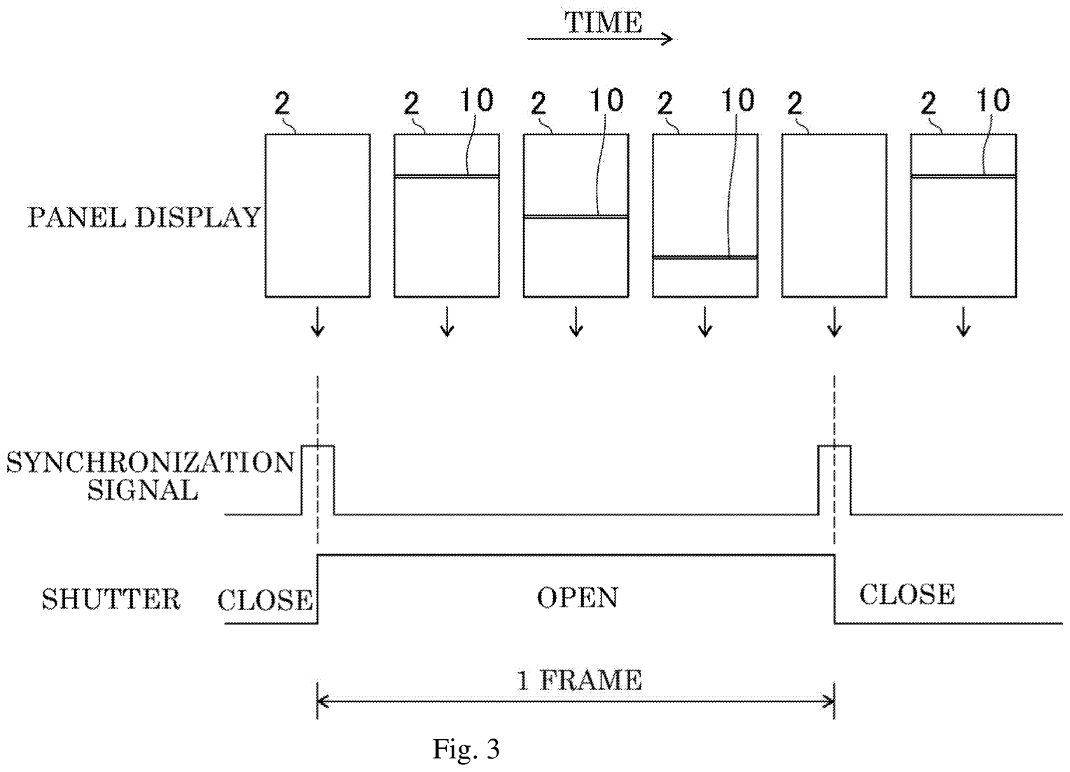

Here, as shown in FIG. 3, the pattern generation device 5 outputs a vertical synchronization signal for each frame in which a black band 10 moves from the top to the bottom of the organic EL panel 2, and when the black band 10 moves to the bottom of the organic EL panel 2, the black band 10 is not displayed on the organic EL panel 2 during a vertical blanking period in which the black band 10 returns to the top of the organic EL panel 2. The control unit 7 causes the camera 3 to capture an image of the organic EL panel 2 on which the red test pattern has been displayed, by opening a shutter of the camera 3 in coordination with that vertical synchronization signal, that is, in coordination with the output timing of a certain vertical synchronization signal (while the synchronization signal is at a high level, during a certain vertical blanking period in which the black band 10 does not exist), and closing the shutter of the camera 3 in coordination with the output timing of the next vertical synchronization signal (while the synchronization signal is next at a high level, during the next vertical blanking period in which the black band 10 does not exist)(step 14), and then the control unit 7 stores the captured image of the red test pattern in the captured image storage unit 8 (step 15).

Also, the control unit 7 instructs the pattern generation device 5 to transmit a test pattern display signal (G signal) to the organic EL panel 2, and displays a green test pattern on the organic EL panel 2 (step 16). The green test pattern is a green image displayed on the entire organic EL panel 2, in which all the pixels of the organic EL panel 2 exhibit green with a predetermined tone. The control unit 7 causes the camera 3 to capture an image of the organic EL panel 2 on which the green test pattern has been displayed, by opening the shutter of the camera 3 in coordination with the output timing of a certain vertical synchronization signal (while the synchronization signal is at a high level, during a certain vertical blanking period in which the black band 10 does not exist), and closing the shutter of the camera 3 in coordination with the output timing of the next vertical synchronization signal (while the synchronization signal is next at a high level, during the next vertical blanking period in which the black band 10 does not exist)(step 17), and then the control unit 7 stores the captured image of the green test pattern in the captured image storage unit 8 (step 18).

Furthermore, the control unit 7 instructs the pattern generation device 5 to transmit a test pattern display signal (B signal) to the organic EL panel 2, and displays a blue test pattern on the organic EL panel 2 (step 19). The blue test pattern is a blue image displayed on the entire organic EL panel 2, in which all the pixels of the organic EL panel 2 exhibit blue with a predetermined tone. The control unit 7 causes the camera 3 to capture an image of the organic EL panel 2 on which the blue test pattern has been displayed, by opening the shutter of the camera 3 in coordination with the output timing of a certain vertical synchronization signal (while the synchronization signal is at a high level, during a certain vertical blanking period in which the black band 10 does not exist), and closing the shutter of the camera 3 in coordination with the output timing of the next vertical synchronization signal (while the synchronization signal is next at a high level, during the next vertical blanking period in which the black band 10 does not exist)(step 20), and then the control unit 7 stores the captured image of the blue test pattern in the captured image storage unit 8 (step 21).

After capturing an image of each test pattern, the control unit 7, based on the results of detecting the position of the image of the red alignment pattern in step 10 and the captured image of the red test pattern, generates unevenness correction data for reducing luminance unevenness when red is displayed on the organic EL panel 2 (step 22), and stores the generated unevenness correction data in the unevenness correction data storage unit 9 (step 23). Specifically, because the control unit 7 knows which image capturing elements of the camera 3 that the above-described specific pixels of the organic EL panel 2 correspond to based on the results of detecting the position of the image of the red alignment pattern, with respect to an image capturing element that does not correspond to the above-described specific pixels, it is possible to obtain which pixel or area of the organic EL panel 2 that the image capturing element corresponds to by an operation such as interpolation. That is, the luminance of each pixel or each area of the organic EL panel 2 is obtained based on the captured image of the red test pattern (the amount of light received by each image capturing element of the camera 3 when capturing an image of the red test pattern). Two-dimensional luminance distribution data at the time of red display on the organic EL panel 2 can be obtained, so the control unit 7 inverts that two-dimensional luminance distribution data to generate unevenness correction data (an image correction table).

As in steps 22 and 23, the control unit 7, based on the results of detecting the position of the image of the green alignment pattern in step 11 and the captured image of the green image, generates unevenness correction data for reducing luminance unevenness when green is displayed on the organic EL panel 2 (step 24), and stores the generated unevenness correction data in the unevenness correction data storage unit 9 (step 25). Also, the control unit 7, based on the results of detecting the position of the image of the blue alignment pattern in step 12 and the captured image of the blue test pattern, generates unevenness correction data for reducing luminance unevenness when blue is displayed on the organic EL panel 2 (step 26), and stores the generated unevenness correction data in the unevenness correction data storage unit 9 (step 27).

The control unit 7 writes the respective items of unevenness correction data when displaying red, green, and blue that were stored in the unevenness correction data storage unit 9 to the above-described ROM using the ROM writer 6 (step 28). By installing an image quality adjustment circuit including this ROM in the organic EL panel 2, an organic EL panel with adjustable image quality is completed. In this organic EL panel with adjustable image quality, as described above, when an image signal is input, the image quality adjustment circuit refers to the unevenness correction data written to the ROM to add a correction value to the input signal, and thus luminance unevenness of the organic EL panel 2 is suppressed.

According to this unevenness correction data generation device 1, the camera 3 captures a test pattern image that has been displayed on the organic EL panel 2 by opening the shutter from one vertical blanking period to another vertical blanking period of that test pattern image, based on the synchronization signal of the pattern generation device 5, so exposure is performed while the black band 10 caused by rewriting the display image in the organic EL panel 2 moves from the upper end of the organic EL panel 2 to the lower end exactly once or a plurality of times, and the black band 10 affects the captured image not partially but overall, and therefore a band-like area of low luminance is not created in the captured image. Consequently, it is possible to prevent capturing of the black band 10 caused by rewriting the display image when capturing an image of the organic EL panel 2 in order to generate unevenness correction data for the organic EL panel 2.

Here, specifically, the “other vertical blanking period” is the next vertical blanking period after the “one vertical blanking period”, and exposure is performed only while the black band 10 moves from the upper end of the organic EL panel 2 to the lower end exactly once. Therefore, it is possible to complete image capturing of the test pattern of the organic EL panel 2 in an extremely short time period of about the reciprocal of the frame rate (if the frame rate is 60 fps, about 1/60 of a second).

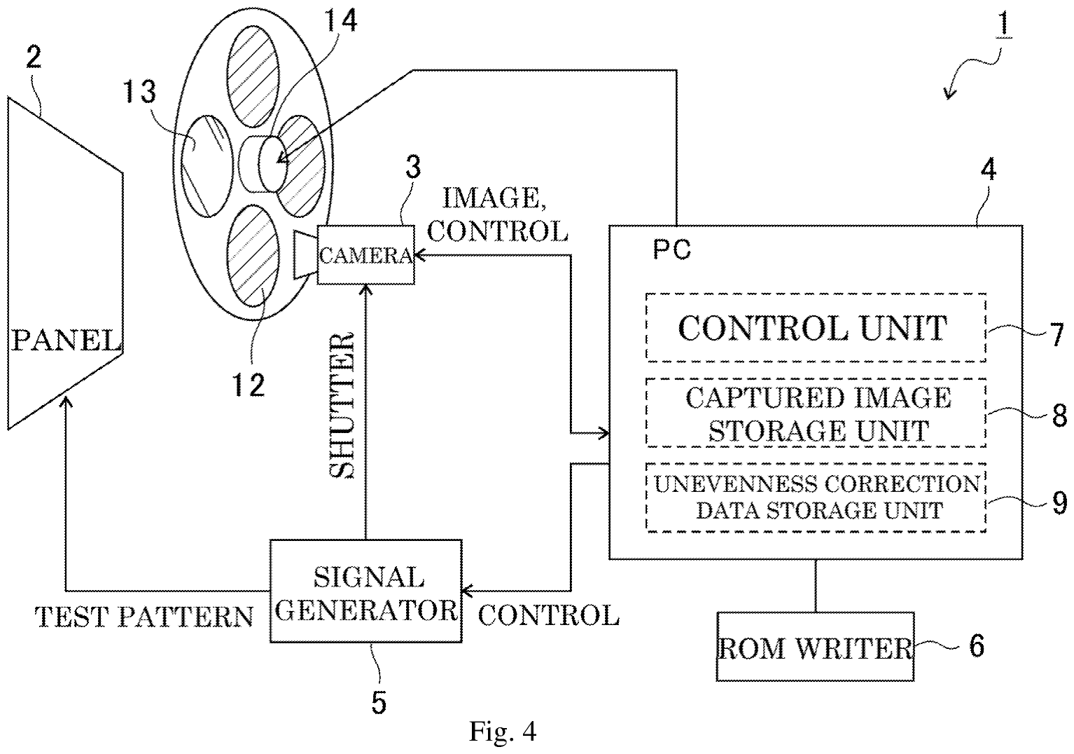

FIG. 4 shows another unevenness correction data generation device according to this example embodiment. This unevenness correction data generation device 11 includes an ND filter 12 and a transparent plate 13 configured to be interchangeably inserted into or removed from the optical system of the camera 3, and an insertion/removal device 14 performing that insertion/removal. Otherwise, the unevenness correction data generation device 11 has the similar configuration as the unevenness correction data generation device 1.

The ND filter 12 reduces the amount of incident light of the camera 3, and the material and shape of the transparent plate 13 are determined such that the air conversion length of the transparent plate 13 is substantially the same as the air conversion length of the ND filter 12. The ND filter 12 and the transparent plate 13 are interchangeably inserted into or removed from the optical system of the camera 3 by the insertion/removal device 14, and the insertion or removal operation may be automatically performed by the control unit 7, but this is not necessary.

According to this unevenness correction data generation device 11, when the display image is bright and it seems likely that latitude will be exceeded even though the “other vertical blanking period” is the “next vertical blanking period” after the “one vertical blanking period” and the shutter is opened for only a short time period (only about 1/60 of a second when the frame rate is 60 fps), it is possible to prevent blown out highlights or saturation of the captured image by inserting the ND filter 12 into the optical system of the camera 3 with the insertion/removal device 14.

On the other hand, when the ND filter 12 is not inserted into the optical system of the camera 3, the transparent plate 13 with substantially the same air conversion length as the ND filter 12 is inserted by the insertion/removal device 14 to maintain the same refractive index as a state in which the ND filter 12 is inserted. Thus, focus adjustment of the camera 3 expected to be necessary due to the presence or absence of the ND filter 12 can be made unnecessary.

As described above, in order to prevent blown out highlights or saturation of the captured image when there is a risk of exceeding the latitude even with the shutter open for the time length of one frame from the “one vertical blanking period” to the “next vertical blanking period”, it is also possible to adopt a configuration in which image capturing is performed with the aperture value narrowed down such that the camera 3 does not exceed the latitude, or a configuration in which the pattern generation device 5 is capable of reducing the interval of the vertical blanking period of the test pattern image (for example, changing the frame rate from 60 fps to 90 fps, or to 120 fps).

Although example embodiments of the present invention are described above, the invention is not limited to the example embodiments described above, and these example embodiments may be appropriately modified in a range not departing from the gist of the invention.

For example, the display panel is not limited to an organic EL panel, and may be a liquid crystal panel, a plasma display, a projection-type projector, or the like.

Also, the camera may be a color camera instead of a monochrome camera. The correction data may be generated for each tone based on a captured image of a test pattern of a plurality of tones, instead of based on a captured image of a test pattern of one tone. The test pattern may be grayscale instead of the colors red, green, and blue.

Furthermore, the vertical blanking period for closing the shutter does not necessarily have to be the next vertical blanking period after the vertical blanking period for opening the shutter, and in this case, the exposure time is approximately an integer multiple of the reciprocal of the frame rate (an integer of 2 or more).

### LIST OF REFERENCE NUMERALS

1 Unevenness correction data generation device

2 Organic EL panel (display panel)

3 Camera (image capturing means)

4 Image quality adjustment device (data generation means)

5 Pattern generation device (signal generation means)

6 ROM writer

7 Control unit

8 Captured image storage unit

9 Unevenness correction data storage unit

10 Black band

11 Unevenness correction data generation device

12 ND filter

13 Transparent plate (transparent member)

1. An unevenness correction data generation device comprising:
a signal generation means for outputting an image signal and a synchronization signal to a display panel;
an image capturing means for capturing a display image of the display panel to which the image signal was input; and
a data generation means for, based on the results of image capturing by the image capturing means, generating unevenness correction data for correcting unevenness of the display panel;
wherein the image capturing means captures the display image by opening a shutter from one vertical blanking period to another vertical blanking period of the display image, based on the syncronization signal.

2. The unevenness correction data generation device according to claim 1,
wherein the other vertical blanking period is the next vertical blanking period after the one vertical blanking period.

3. The unevenness correction data generation device according to claim 2,
wherein the image capturing means captures the display image at an aperture value not exceeding a latitude when the shutter is opened from the one vertical blanking period to the next vertical blanking period.

4. The unevenness correction data generation device according to claim 1, comprising:
an ND filter configured to be inserted into or removed from an optical system of the image capturing means; and
a transparent member with substantially the same air conversion length as the ND filter and configured to be inserted into or removed from the optical system instead of the ND filter.

5. The unevenness correction data generation device according to claim 1,
wherein the signal generation means is capable of changing the interval of the vertical blanking period of the display image.

6. The unevenness correction data generation device according to claim 2, comprising:
an ND filter configured to be inserted into or removed from an optical system of the image capturing means; and
a transparent member with substantially the same air conversion length as the ND filter and configured to be inserted into or removed from the optical system instead of the ND filter.

7. The unevenness correction data generation device according to claim 2,
wherein the signal generation means is capable of changing the interval of the vertical blanking period of the display image.

8. The unevenness correction data generation device according to claim 3,
wherein the signal generation means is capable of changing the interval of the vertical blanking period of the display image.

9. The unevenness correction data generation device according to claim 4,
wherein the signal generation means is capable of changing the interval of the vertical blanking period of the display image.

10. The unevenness correction data generation device according to claim 6,
wherein the signal generation means is capable of changing the interval of the vertical blanking period of the display image.
